(19) United States
(12) Patent Application Publication
(10) Pub. No.: US 2016/0277575 A1
(43) Pub. Date: Sep. 22, 2016

(54) CALL CENTER SYSTEM FOR PERSONALIZED SERVICES

(71) Applicant: Amos Joseph Alexander, Santa Maria, CA (US)

(72) Inventor: Amos Joseph Alexander, Santa Maria, CA (US)

(21) Appl. No.: 15/168,544

(22) Filed: May 31, 2016

Related U.S. Application Data
(63) Continuation-in-part of application No. 13/998,276, filed on Oct. 18, 2013.

(51) Int. Cl. H04M 3/51; H04M 3/42

(52) U.S. Cl. CPC H04M 3/5166; H04M 3/42068; H04M 3/5191; H04M 3/5116; H04M 2242/12; H04M 2242/10

(57) ABSTRACT

A call center system comprising a hub call center system, a number of spoke call center systems and third party resources. The hub call center system is configured to connect a communication received from a client device through communication channels provided by the hub call center system over a network with an associate of the hub call center system to deliver personalized services to a registered user. A data store is configured to maintain a personal information record of the registered user. The spoke call center systems are configured to enable associates of the spoke call center systems to work in conjunction with the hub call center system to provide the personalized services. The third party resources are deployed for providing the personalized services as per requirement by the hub call center system or by the spoke call center systems.

### CROSS-REFERENCE TO RELATED APPLICATION

This application is a continuation-in-part of U.S. patent application Ser. No. 13/998,276 filed on Oct. 18, 2013, which is incorporated in its entirety herein by reference.

### FIELD OF THE INVENTION

The present invention relates to call center technologies. More particularly, the present invention relates to a call center facility that provides personalized services to meet the various non-emergency and urgent needs of registered users.

### BACKGROUND OF THE INVENTION

The existing call center systems offer various kinds of services to callers. Most of the call centers can provide general information, and/or they can provide a service to a caller. Information can consist of looking up a nearby dealer to repair a product, for example. A well-known example of call center based service is for technical support, such as for a computer problem. Based on the model of one's computer the customer service representative (CSR) or associates within a call center can follow a script to help troubleshoot common computer error indications for a particular computer model, and additionally provide warranty information based on the CSR's record of when the consumer bought the computer. However, each of such services has their own respective number that a phone user would need to call separately to get the respective service or help.

Also, people these days are becoming increasingly aware that they need to be more proactive when it comes to preserving their health and safety, both for themselves and their family. This is particularly the case for users who choose to travel in a world in which there is increasing unrest. However, most of the call center services are not customized for the personal need of the callers.

Thus, there is a need for a call center system which can provide personalized services for meeting the health and safety needs of registered users through the use of a single help line or user interface.

### OBJECTS OF THE INVENTION

An object of the present invention is to provide a system for a call center facility which can support a registered user in multiple personal non-emergency situations.

Another object of the present invention is to provide personalized services to registered users of a call center facility.

Yet another object of the present invention is to provide a real time three way translation service to registered users.

Another object of the present invention is to provide a dedicated medical assistance center which can work in conjunction with a main call center.

Still another object of the present invention is to provide a call center facility that enables a registered user to contact the call center in distress situations with codes having predefined meanings known to the call center.

Another object of the present invention is to provide a hub and spoke architecture for a call center which can efficiently handle calls related to a registered user as per situational demands.

Yet another object of the present invention is to provide a call center facility that can simultaneously handle multiple calls related to the personal needs of a registered user.

Still another object of the present invention is to provide a call center facility that enables emergency roadside assistance payment to third parties on behalf of a registered user from the account of said registered user.

Details of the foregoing objects and of the invention, as well as additional objects, features and advantages of the invention will become apparent to those skilled in the art upon consideration of the following detailed description of the preferred embodiments exemplifying the best mode of carrying out the invention as presently perceived.

### BRIEF SUMMARY OF THE INVENTION

The following presents a simplified summary in order to provide a basic understanding of some aspects of the disclosed invention. This summary is not an extensive overview, and it is not intended to identify key/critical elements or to delineate the scope thereof. Its sole purpose is to present some concepts in a simplified form as a prelude to the more detailed description that is presented later.

The present invention is directed to a system for a call center facility which provides personalized services to its registered users. In one embodiment, the call center system of the present invention works in a hub and spoke architecture with a main call center as the hub (referred to as hub call center hereinafter) and one or more additional call centers as spokes (referred to as spoke call centers hereinafter). The hub call center provides a single user interface including help lines and web enabled user interface to the customer for receiving communications while the seamless extensions of spoke call centers leverage to provide additional value added services to the users. Examples of spoke call centers include, but are not limited to, a translation call center system which provides real time language translation service to registered users and a nurse call center system which can provide medical assistance to the registered users. Upon their initial signup with the call center system, users are required to provide personal information including personal medical information, information of family/friends who can be contacted for help in case of a particular situation etc. The personal information record of a registered user can be retrieved instantly when the registered user or someone else on behalf of the registered user contacts the call center system so that customized or personalized services can be provided to the registered users. The call center system enables the associates or the customer service representatives (CSRs) to contact third party resources such as local hospitals, medical clinics, transportation services, official 911 emergency operators, local police, fire, rescue and medical emergency departments etc. for providing service to the registered users as per requirement. A registered user can use his/her phone to contact the call center system by dialing a dedicated help line number or by starting a web chat session through the user interface provided by the call center system for seeking assistance in case of non-emergency needs and in case of personal urgent needs. Examples of non-emergency needs include navigation needs, travel information need, language translation need etc. On the other hand, personal urgent needs include need for assistance/help in case of a medical condition or in case of a real or perceived threat situation etc.

To the accomplishment of the foregoing and related ends, certain illustrative aspects of the disclosed invention are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The foregoing features, objects and advantages of the invention will become apparent to those skilled in the art from the following detailed description of a preferred embodiment, especially when considered in conjunction with accompanying drawings in which like numerals in the several views refer to corresponding parts.

FIG. 1 illustrates a general architecture of a call center facility for personal and non-emergency needs of registered users that operates in accordance with an embodiment of the present invention; and

FIG. 2 illustrates a flowchart depicting the general steps associated with the method in accordance with an embodiment of the present invention.

### DETAILED DESCRIPTION OF THE INVENTION

In the following detailed description, numerous specific details are set forth in order to provide a thorough understanding of the invention. However, it will be understood by those skilled in the art that the present invention may be practiced without these specific details. In other instances, well-known methods, procedures and components have not been described in detail so as not to obscure the present invention.

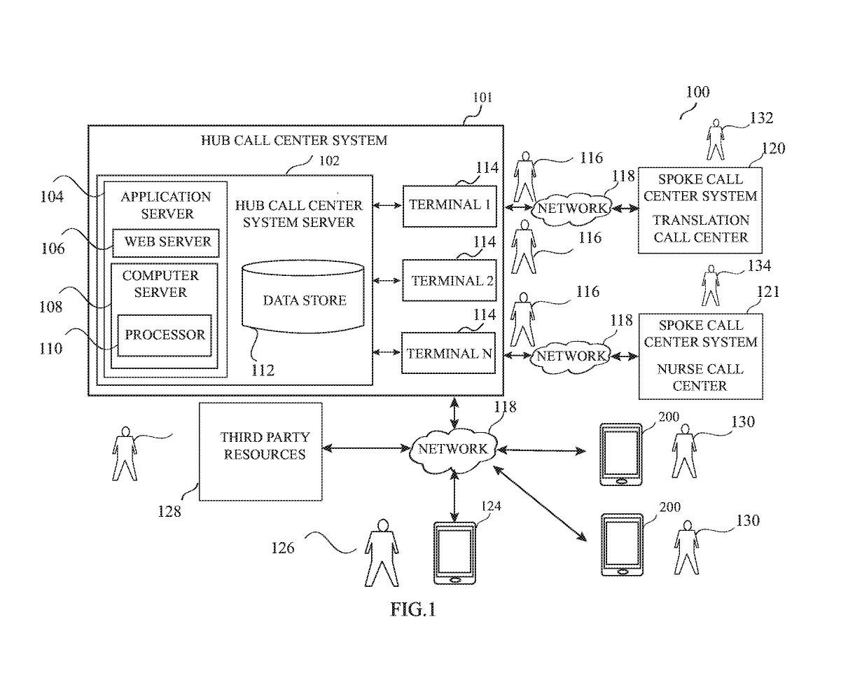

FIG. 1 illustrates general architecture of a call center system 100 that operates in accordance with one embodiment of the present invention for providing personalized services to registered users. The call center system 100 comprises a hub call center system 101, one or more spoke call center systems 120 and 121, one or more third party resources 128 and one or more client devices 124 and 200, all of these being communicatively connected with each other through a network 118. Although, only three client devices 124 and 200 are illustrated in FIG. 1, it is to be understood that there can be a plurality of client devices connected to the hub call center system 101. The hub call center system 101 communicates with the mobile computing devices 124 and 200 over the network 118 to present a user interface and a help line for the call center system 100 of the present invention. The hub call center system 101 provides one or more communication channels over the network 118 to the client devices. The one or more communication channels include a telephone help line and a web chat session. The telephone numbers i.e. help lines can be used by a registered user of the call center system 100 for availing various personalized services. The user interface of the call center system of the present invention can be presented on the mobile computing device through a web browser or through a native mobile application communicating with the hub call center system 101 and is used for displaying, entering and/or managing data for availing various personalized services offered by the call center of the present invention. The web chat is a system for allowing users to communicate in real time with the call center system using easily accessible user interfaces of the call center system on a client device. As used herein, the term “network” generally refers to any collection of distinct networks working together to appear as a single network to a user. The term also refers to the so-called world wide “network of networks” or Internet which is connected to each other using the Internet protocol (IP) and other similar protocols. As described herein, the exemplary public network 118 of FIG. 1 is for descriptive purposes only and it may be wired or wireless. Although, the description may refer to terms commonly used in describing particular public networks such as the Internet, the description and concepts equally apply to other public and private computer networks, including systems having architectures dissimilar to that shown in FIG. 1. The inventive idea of the present invention is applicable for all existing cellular network topologies or respective communication standards, in particular GSM, UMTS/HSPA, LTE and future standards.

With respect to the present description, the hub call center system 101 may include any service that relies on a database system that is accessible over a network, in which various elements of hardware and software of the database system may be shared by one or more users of the call center system 100. The graphical user interface (GUI) or user interface provided by the hub call center system 101 on the client devices 124 or 200 through a web browser or mobile app may be utilized by the users for signing up, logging in, web chat and submitting data, etc.

The hub call center system 101 comprises a hub call center system server 102 and a plurality of terminals 114 communicatively connected with the server system 102. The terminals 114 include computing devices such as desktops, laptops etc. and voice communication devices such as telephones. The terminals 114 are attended by customer service representatives (CSRs) or associates 116. The components appearing in the call center system 100 refer to an exemplary combination of those components that would need to be assembled to create the infrastructure in order to provide the services contemplated by the present invention.

The hub call center system server 102 includes an application server or executing unit 104 and a data store 112. The application server or executing unit 104 comprises a web server 106 and a computer server 108 that serves as the application layer of the present invention. It would be obvious to any person skilled in the art that, although described herein as the data being stored in a single database, different separate databases can also store the various data and files of multiple users.

The Web server 106 is a system that sends out Web pages containing electronic data files in response to Hypertext Transfer Protocol (HTTP) requests from remote browsers (browsers installed in the mobile computing device 124, for example) or in response to similar requests made through a mobile app or mobile application of the present invention installed on a mobile computing device or client device 124 or 200. The web server 106 can communicate with the mobile app of the present invention and/or with a web browser installed on a mobile computing device 124 to provide the user interface required for the call center system 100. The terms “client device” and “mobile computing device” are used interchangeably and alternatively. The mobile computing device comprise a first processor (not shown in the figures) and this first processor is configured to execute one or more instructions stored in a computer readable storage medium included in the mobile computing device.

The mobile application or “mobile app” is a computer program that may be downloaded and installed in mobile computing device 124 using methods known in the art. Hereinafter, the mobile app of the present invention is referred to as personalized call center app. The personalized call center app enables one or more persons to do various tasks related to the personalized call center facility system of the present invention. Examples of mobile computing device or client device 124 and 200 may include, but are not limited to mobile devices, tablets, hand-held or laptop devices, smart phones, personal digital assistants or any similar devices.

The mobile computing devices 124 and 200 may include various electronic components known in the art for this type of device. In this embodiment, the mobile computing device 124 or 200 may include a device display, a geospatial location sensor (e.g., Global Positioning System-GPS sensor), a first processor, user input device (e.g., touch screen, keyboard and/or other form of input device known in the art), a device transceiver for communication, a computer readable device memory and the personalized call center app operably installed in the computer readable memory (not shown in figure). For purposes of this application, the term “transceiver” is defined to include any form of transmitter and/or receiver known in the art, for cellular, WIFI, radio, and/or other form of wireless or wired communication known in the art. Obviously, these elements may vary, or may include alternatives known in the art, and such alternative embodiments should be considered within the scope of the claimed invention.

The hub call center system 101 acts as the main call center whereas one or more spoke call center systems 120 and 121 work in conjunction with the hub call center system 101 to provide other supplementary or specialized services to the users of the call center system 100 as per requirement. The hub call center system 101 is the first line of communication that enables taking inbound calls from registered user 126 and/or from the registered user authorized family, friend 130 and/or medical personnel by dialing an easy-to-remember help line such as 855-SOS-HALO, for example. FIG. 1 illustrates a translation call center system 120 and a nurse call center system 121. The translation call center system 120 provides language translation services whereas the nurse call center system 121 provides medical services to the registered users of the call center system 100.

Continuing with FIG. 1, third party resources 128 represents any vendor/organization/company/individual which can provide various services as per requirement of a user/customer. Examples of a third party vendor or resource may include, but are not limited to, local hospitals, medical clinics, transportation services, official 911 emergency operators, local police, fire, rescue and medical emergency departments, nurse healthcare consultant company, travel.state.gov, an emergency service, etc. As shown in FIG. 1, the third party resources 128 are communicatively connectable to the other components of the personalized call center facility system 100 over the network 118.

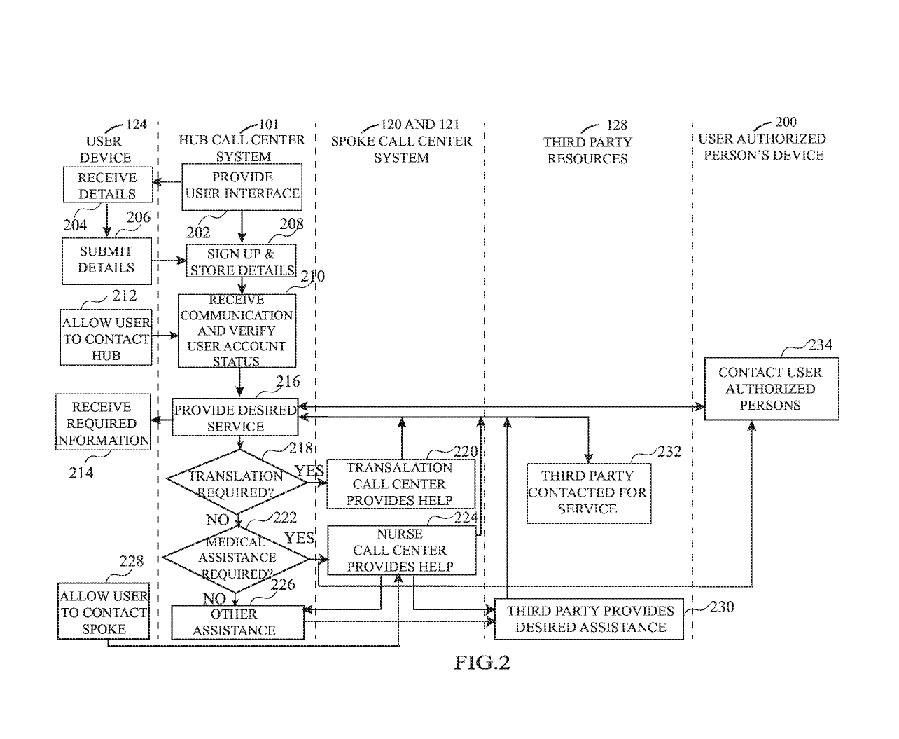

Reference to FIG. 1 and FIG. 2, to avail the personalized services offered by the call center system 100 a person has to become its registered user. For example, a person 126 wants to become a registered user. The hub call center system 101 provides the user interface as in step 202 of FIG. 2 and the person 126 can use this user interface on client device 124 as described above. The person 126 furnishes personal information details through the user interface as in step 204 and, then, submits the details to the hub call center system 101 through the user interface as in step 206. The personal information can be any information that is associated with an identifiable living individual. It can include correspondence address, contact information for self and relatives/friends/neighbors, self medical information, family physician/health care practitioner details, personal financial information etc. Medical information required for registration includes past and current medical history and condition of the user, current medications, known allergies, etc.

The personal information submitted by the person 126 is used for signing up the person 126 as a registered user (hereinafter the person 126 is referred to as a registered user 126) of the call center system 100 and the personal information is stored as personal information record in the data store 112 as in step 208 associated with the identity of the registered user 126.

A registered user of the call center system 100 can contact the hub call center system 101 and/or the spoke call center systems 120 and 121 through the user interface (through a software application operably installed on the client device such as the personalized call center app or through a webpage accessed through a web browser operably installed on the client device) or through a number of telephone help lines such as 855-SOS-HALO and 855-AID-NEED etc. for seeking help/assistance for a number of non-emergency and personal urgent needs that are unique to the registered user's situation.

Example of non-emergency needs include, but are not limited to, person locator need, driving and map direction needs, general information assistance needs and many other non-emergency needs such as need for travel info, translation service etc. For example, the registered user 126 may contact the hub call center system 101 by using the client device 124 (client device 124 is a mobile phone in this instance and 855-SOS-HALO can be dialed from the phone), as in step 212, for seeking turn-by-turn direction assistance wherever the registered user 126 needs to go. The hub call center system 101 will enable, as in step 210, the one or more associates 116 to first verify as to whether the registered user has a valid account with the call center system 100, and, if the registered user 126 holds a valid account, then assist the registered user 126 to find the registered user's destination, to locate a gas station or a restaurant or an ATM etc. as in step 216. The registered user 126 can receive that required information from the hub call center system as in step 214. The registered user 126 can use any other client devices or phones, not necessarily owned by the registered user 126, to contact the call center system 100 through a help line or through a user interface on a web browser.

In one embodiment of the present invention, this call center system 100 uses G.P.S. locator technology which can be supplied to the hub call center system 101 by means of the registered user 126 relaying the geo coordinates (latitude/longitude) of the client device 124. In addition, the data store 112 maintains an internal database with applicable registered user's relevant location information i.e. location of user's home and nearby sources of help that the user believes can be useful, which the user predefines with the call center system 100 on or after signup.

In instances where service of a third party is required, the hub call center enables the associates 116 to contact appropriate third party resources 128 for the purpose. For example, while being stranded at a lonely roadside with a flat tire of his car or when out of gas, the registered user 126 may contact the hub call center system 101. The hub call center system 101 will then enable the associates 116 to contact third party resources 128, as in step 232, for help such as for towing arrangement or for arranging alternate transportation etc.

In one embodiment, the call center system 100 of the present invention enables the CSRs to give turn-by-turn directions to the trusted family/friends of the registered users to vector help to the user faster. According to one embodiment of the present invention, the call center system 100 interconnects customer service representatives (the terms CSR and associate are used herein alternatively and interchangeably) 116 within the hub call center system 101 with the ability to communicate with one another for the purpose of simultaneously providing services (such as turn-by-turn-directions) to multiple friends, family of the registered users and medical responders to get help to a user faster should the user have a personal urgent need.

In a preferred embodiment, the spoke call centers 120 and 121 can be patched on the line with the hub call center system 101 to provide a new level of personalized assistance to the caller as per requirement. Reference to FIG. 1, the spoke center 120 is a translation call center which provides language translation services with a plurality of language coverage. If a registered user contacts the call center system 100 for language translation service, as in step 218, the hub call center system 101 patches in the translation call center 120 to enable the CSR 132 in the translation call center 120 to act as a translator, as in step 220, between the registered user and anyone around him who does not speak his language (wherever the registered user may be in the world). This feature of the present invention utilizes the call center system 100 to provide a unique service to turn any phone into a live 24/7 talking global translator that helps traveling registered users in a novel way.

Example of personal urgent needs include various assistances that may be required by a registered user during a medical emergency or when in a distress/dangerous situation. The nurse call center 121 of the present invention enables registered nurses 134 to assist registered users of the call center system 100 with medical-related assistance or information. In addition, the nurse call center 121 comprises multi-lingual Registered Nurses that assist multilingual-speaking registered users of the call center system with medical-related assistance and/or information.

A registered user 126 may contact the hub call center system 101 for any medical assistance and, as in step 222, the hub call center system 101 can patch the nurse call center 121 in for providing the registered user 126 with required medical assistance. The nurse call center can also contact third party resources 128 for providing the required medical assistance. The call center system 100 pulls the medical information of the registered user from the data store 112 and presents the information to the associates or nurse. The personal medical information of the registered user is referred to by the associates/nurse for providing appropriate medical assistance to the registered user. This feature helps in saving valuable time in case of medical emergencies which otherwise may get wasted in getting the required information of the user. By contacting the various resources, the hub call center system 101 and/or the nurse call center system 121 can assist the registered user in providing a particular service(s) and/or information. The hub call center system 101 can coordinate with the respective resources with the nurse call center 121 and the registered user on the call at the same time. Further, the hub call center system 101 enables the CSRs 116 to contact one or more registered user's authorized persons 130 such as relatives, friends, family physician etc. on client devices 200 as per the list of individuals authorized by the registered user to contact at such emergency situations as in step 234.

In a preferred embodiment, the call center system 100 enables a registered user to contact the nurse call center 121 directly in an urgent medical situation. For example, the registered user 126 can dial 855-AID-NEED to contact the nurse call center 121 directly as in step 228 when the registered user is at the local park and feeling the onset of a seizure. The nurse call center 121 gives immediate nurse advice. The nurse call center 121 also patches to the hub call center 101, as in step 224, and the CSR at hub call center looks up the registered user's record for his/her medical condition, special needs during a medical episode, and the list of individuals to contact as in step 226. The CSR then makes phone notification(s) to the user's friends/family/family physician telling them that the user is having a seizure at the local park or the CSR may contact a third party as in step 230 for assistance. The CSR at the hub call center provides the best friend/family physician with the info about the user's health need and location for the purpose of rendering personalized assistance as appropriate for their medical condition. The best friend then has the information he needs to go to the user's location to render the personalized medical assistance necessary for their health need.

The nurse call center 121 can perform a quick global hospital lookup via a global directory of hospitals they can readily access, or they can connect by telephone with the hub call center system 101 for CSR dedicated help with making notifications and/or looking up extensive information regarding medical clinics and health care providers. The nurse call center can assist the registered user in providing more in-depth medical services and/or information by coordinating with the respective resources.

Each registered user is provided with their own personalized webpage on the user interface to serve as their portal to receive online services. On the webpage of the user interface, registered users may click a link to immediately chat with a customer service representative in the hub call center system 101. On their personalized webpage, the registered users are also provided with web links so they can easily connect with publicly available information (i.e. travel info). In addition, they are able to view first aid videos embedded on the webpage. Also, registered users can request their webpage be customized to their specifications at any time. For example, if a registered user goes on a traveling trip, they may want their first aid and travel-related links revised on their web page to accommodate their personalized informational needs depending on the location they are going to. With the proliferation of smartphone technology, this puts the information they need right at their fingertips on any web-enabled phone they may use as client device. In addition, CSRs have an Internet lookup capability to search publicly available information online to meet the health, safely, travel, and other needs of registered users. This can be particularly convenient and useful for travelers, for example, who look to us for quality information with a single phone call. To further assist traveling users for example, CSRs in the hub call center system 101 are fully trained to e-mail relevant travel-related links to the traveling user, whereupon the user can quickly access public online travel information via any web-capable modern phone.

The call center system 100 also enables a registered user to open a web chat session through the user interface on the client device with the hub call center 101. Registered users are asked to preset or predefine one or more codes comprising, for example, short words or numbers to be used as distress/duress codes. The registered users define the meaning of these distress codes and also define the course of action to be taken by the call center system 100 upon receiving such distress codes from the registered users. Since, the meaning of the distress codes can be quickly retrieved from the database as part of the registered user's profile information, when a distress code is received by the call center system 100 from any of its registered users, the CSRs or the associates can easily decode the distress code and take appropriate action as predefined by the users. Thus, the registered user (for example a woman walking late at night) can open up a chat session with the call center system 100 via the web portal that she can access on the user interface presented on her web-enabled phone. At any time when discretion is important for safety she can quickly web chat her distress code to the call center through the user interface, whereupon the CSR within the call center will refer to her electronic personal record and follow her pre-defined instructions to make rapid notifications to friends and family. Registered users may even predefine a route with the call center so CSRs will know the registered user's common route and direction of travel when that duress code is sent in. This feature of sending distress code via user interface is referred to as Silent Alarm feature. The Silent Alarm feature is ideal for those situations when requesting help is most safely done silently, in a discreet fashion. In such cases, CSRs in the hub call center system 101 are trained to relay this request for help onto friends/family/local security guards, etc along with the location and direction of travel (if known). These personnel can then be vectored to the registered user's location to quickly preserve the registered user's safety and render any personal assistance as needed.

In an embodiment, a third party can also contact the hub call center system 101 in the interest of a registered user. For example, if the registered user meets with an accident a paramedic can call 855-SOS-HALO after finding the number on the incapacitated user's wallet card (personalized wallet card is provide to the registered users by the call center system 100). The CSR at hub call center system 101 accesses the user's record telling the paramedic the user's existing medical conditions, drug allergies, and personal preferences regarding the care of their health. The CSR passes the info to the paramedic and collects the necessary info from the paramedic as to which hospital will the user be taken. The CSR also notifies the user's contacts in the order they pre-defined on their initial intake form (for example, contact father first and then relatives/kins). These individuals can then be simultaneously routed to the user's location to render personalized assistance (bringing the user's medication from home, etc).

The call center system 100 also enables pay-by-phone service to the registered users. For example, if a registered user becomes stranded by the roadside and is short on funds to pay for a service (i.e. car towing) he/she can contact the call center system 100 for assistance. The CSR at hub call center system checks the user record and verifies if the user has credit of funds on his/her account maintained at the call center system. The call center system then enables making payment to the third party (i.e. car towing agency in this instance) from the registered user's account.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. All methods described herein can be performed in any suitable order unless otherwise indicated herein or otherwise clearly contradicted by context. The use of any and all examples, or exemplary language (e.g., “such as”) provided herein, is intended merely to better illuminate embodiments of the invention and does not pose a limitation on the scope of the invention unless otherwise claimed. No language in the specification should be construed as indicating any non-claimed element as essential to the practice of the invention.

The flowchart is used to describe the steps of the present invention. While the various steps in the flowchart are presented and described sequentially, some or all of the steps may be executed in different orders, may be combined or omitted, and some or all of the steps may be executed in parallel. Further, in one or more of the embodiments of the invention, one or more of the steps described above may be omitted, repeated, and/or performed in a different order. In addition, additional steps, omitted in the flowcharts may be included in performing this method. Accordingly, the specific arrangement of steps shown in FIG. 2 should not be construed as limiting the scope of the invention

Preferred embodiments of this invention are described herein. Variations of those preferred embodiments may become apparent to those of ordinary skill in the art upon reading the foregoing description. The inventor expects skilled artisans to employ such variations as appropriate, and the inventor intends for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A call center system, said system comprising:
a hub call center system, said hub call center system configured to connect a communication received from a client device through one or more communication channels provided by said hub call center system over a network with one or more associates of said hub call center system;
a data store configured to maintain a personal information record of said registered user;
one or more spoke call center systems, said one or more spoke call center systems configured to enable one or more associates of said one or more spoke call center systems to work in conjunction with said hub call center system; and
one or more third party resources, said one or more third party resources are deployable as per requirement by said hub call center system or said one or more spoke call center systems;
wherein one or more personalized services are provided by said call center system to said registered user in response to said communication.

2. The call center system as in claim 1, wherein said one or more spoke call center systems comprise a translation call center that provides a language translation service as a part of said one or more personalized services.

3. The call center system as in claim 1, wherein said one or more spoke call center systems comprise a nurse call center that provides a medical assistance service as a part of said one or more personalized services.

4. The call center system as in claim 1, wherein said one or more personalized services include making contact with one or more said registered user's authorized persons as per requirement.

5. The call center system as in claim 1, wherein said one or more personalized services are customized depending on said personal information record.

6. The call center system as in claim 1, wherein said one or more communication channels comprise a telephone help line.

7. The call center system as in claim 1, wherein said one or more communication channels comprise a web chat.

8. The call center system as in claim 7, wherein said web chat involves sending of one or more duress codes with predefined meanings by said registered user for enabling said one or more associates to take appropriate action.

9. The call center system as in claim 1, wherein said hub call center system and said one or more spoke call center systems enable a plurality of said one or more associates to work simultaneously for providing said one or more personalized services.

10. The call center system as in claim 1, wherein said user interface presents a personalized webpage to said registered user.

11. A method for providing one or more personalized services to a registered user of a call center system, said method comprising:
providing a hub call center system;
storing a personal information record of said registered user in a data store;
receiving a communication from or on behalf of said registered user through one or more communication channels provided by said hub call center system over a network;
providing one or more spoke call center systems to work in conjunction with said hub call center system;
contacting one or more third party resources by said hub call center system or by said one or more spoke call center systems as per requirement;
customizing said one or more personalized services to be provided to said registered user depending on said personal information record and on type of said communication; and
providing said one or more personalized services to said registered user.

12. The method as in claim 11, wherein said one or more spoke call center systems comprise a translation call center that provides a language translation service as a part of said one or more personalized services.

13. The method as in claim 11, wherein said one or more spoke call center systems comprise a nurse call center that provides a medical assistance service as a part of said one or more personalized services.

14. The method as in claim 11, wherein said one or more personalized services include making contact with one or more said registered user's authorized persons as per requirement.

15. The method as in claim 11, wherein said one or more communication channels comprise a telephone help line.

16. The method as in claim 11, wherein said one or more communication channels comprise a web chat session.

17. The method as in claim 11, wherein said hub call center system and said one or more call center systems enable a plurality of associates to work simultaneously for providing said one or more personalized services
